(19) United States
(12) Patent Application Publication
(10) Pub. No.: US 2007/0144214 A1
(43) Pub. Date: Jun. 28, 2007

(54) Fiberizing bushing cooling system and method

(76) Inventor: Terry Joe Hanna, Millersport, OH (US)

Correspondence Address: JOHNS MANVILLE, 10100 WEST UTE AVENUE, LITTLETON, CO, 80127, US

(21) Appl. No.: 11/320,135

(22) Filed: Dec. 28, 2005

(51) Int. Cl. C03B 9/16; C03B 37/07; C03B 37/10

(52) U.S. Cl. 65/377; 65/384; 65/481; 65/488; 65/510; 65/171

(57) ABSTRACT

Methods and systems for substantially improving the stability of a melting furnace system that includes bushings and cooling apparatus for converting molten mineral material to continuous fibers is disclosed. Apparatus and methods for maintaining the molten material throughput and the electrical power load on fiberizing bushings substantially constant are disclosed. The orifice plate, with or without tips or nozzles, is subjected to a more rapid rate of heat removal after the bushing breaks out than it did while the bushing was in a desired fiberizing mode. Apparatus that can respond quickly following a recognition that a bushing has broken out to increase cooling of the orifice plate or tip plate of a bushing is disclosed as is methods for using this apparatus to achieve the objective stated above.

The invention involves apparatus for cooling including positioning apparatus for cooling members beneath a fiberizing bushing and water fogging or misting apparatus that is/are activated when the bushing breaks out, and a method for making fiber from a molten material such as molten glass using this apparatus. More particularly, the present invention involves an apparatus for bushing assemblies, and a method for making fiber, that provide a more uniform temperature profile across the orifice/tip plate of the bushings and a better molten material temperature control capability for the melting furnace, forehearth(s), bushing legs and the bushings.

### BACKGROUND

In the manufacture of mineral fiber from molten material, it has been common practice to use a bushing made of precious metals including platinum, rhodium, palladium, ruthenium, iridium and alloys thereof. The bushings are electrically heated by their own resistance and are usually box-like, open on the top and comprise an orifice plate containing hundreds or thousands of orifices, with or without nozzles or tips welded or formed thereon, as shown by U.S. Pat. Nos. 4,207,086 and 4,078,413, which disclosures are hereby incorporated by reference.

As the molten material emerges from the orifices or tips, a meniscus or cone of molten material is formed below each orifice or tip from which a fiber is pulled continuously. This is the objective, but if the temperature of the meniscus is not carefully controlled, or the molten glass contains small stones, other inclusions or chords, one or more fibers break, requiring a costly stoppage of desired fiberization from that bushing and a beading down and restart of the desired fiberization. To remove the heat from the meniscus and fiber that must be removed to cool the molten or plastic fiber so that it will have integrity and strength to endure the remainder of the process of making a fiber product, cooling members are located close to the orifices or nozzle tips. These cooling members can be either cooling tubes like shown in U.S. Pat. Nos. 4,397,665, 5,244,483 and 6,196,029, the disclosures of which are hereby incorporated by reference, or cooling fins as are well known in the fiber industry.

Occasionally, and sometimes frequently, a fiber will break beneath the bushing for various reasons that are known. When a fiber break occurs, the loose fiber soon causes other fibers to break and soon all, or most, fibers being formed beneath the bushing are broken, a stoppage of desired fiberization. This is called a “breakout” in the industry. After a breakout begins, it is necessary to wait a short time, usually tens of seconds up to a few minutes, for beads of molten glass to form beneath each bushing orifice or tip, and become large enough that they break loose and fall from the bottom of the orifice plate or tip pulling a very coarse fiber, called a primary fiber, onto the floor, into a scrap bin, basement or scrap bin beneath the forming room floor. This is normally called “beading out” in the industry. Once beaded out, or as soon as the operator is available, the operator or starting equipment can then restart a strand containing the primary fibers into a chopper or winder and again begin making the desired product. Detectors for detecting when a breakout is occurring are known as evidenced by U.S. Pat. Nos. 4,130,406, 4,229,198, 4,342,579, 3,432,580, 4,401,452, and 4,925,471.

When the bushing is running good product the fibers are moving away from the bottom of the bushing at a speed of thousands of feet per minute. This downward movement at this speed, of an array of hundreds or thousands of fibers, creates, due to friction between the air surrounding the fibers and the surface of the fibers, a partial vacuum (lower pressure zone) by pulling a stream of air downward. The partial vacuum causes a flow of cooling air from the surroundings into the array close to the orifice plate and tips of the bushing. This flow of inspirated air coming from outside the array of fibers cools the tips, meniscuses and the newly formed fibers. The cooling of the bushing, tips and orifice plate, causes additional electrical power to be applied to the bushing automatically to maintain the set-point temperature.

When the bushing breaks out, this inspirated cooling flow of cooling air stops. At that time several more undesirable things begin. The set point thermocouple begins to heat up because of the loss of cooling air and as it does, the controller decreases the electrical power heating the bushing. As the electrical power is decreased during the beading out and hanging periods, the molten glass through-put decreases by 5-15 percent, slowing the flow of molten glass through the well, orifice, between the forehearth leg above the bushing and the bushing causing the temperature of the molten glass in the well, and thus the molten glass entering the bushing, to drop substantially, about 25-75 degrees F. This colder glass coming into the bushing causes the molten glass exiting the orifices to be colder and thus to have a higher viscosity. The higher viscosity glass has more resistance to attenuation when desired fiberization is begun, causing higher stress in the fiber at its weakest point, and it frequently breaks. This is why the break rate is normally highest during the first 10-20 minutes or longer after restart of desired fiberization, particularly as the area of the orifice/tip plate of the bushings has increased to accommodate mote orifices/tips. The larger the area of the orifice/tip plate, the greater the tendency to have a higher temperature variance across the orifice/tip plate or tips. It normally takes about 10-20 minutes or longer for the molten glass in, and exiting, the bushing to again reach the desired fiberizing temperature.

The above conditions apply to any molten material and are most costly in the manufacture of so-called “continuous” glass fiber products from molten glass. This condition has been addressed in the past by the use one or more air tubes below the bushing that run continuously or intermittently to try to cause cooling air stream to be inspirated into the bushing tips, the array of newly formed fibers, beads, or primary fibers below the tips even after the bushing has broken out. This is disclosed in U.S. Pat. No. 4,662,922. This improved the break rate, but is not sufficient, particularly on large bushings having one or two thousand or more tips, to prevent the problems described above.

In the manufacture of continuous glass fibers, melting furnaces are typically used to melt batch, refine the molten glass, and to feed molten glass through one or more forehearths and usually a plurality of bushing legs to the bushings. It is extremely important, to achieve a very low break rate, bushing breakout rate, that the molten glass coming to the bushings is fully melted and uniform in temperature and chemistry. Mixing in the molten glass is mainly dependent upon maintaining desired temperature gradients in the melting furnace. There are typically hundreds of thousands of pounds of molten glass, often about 500,000 pounds, in a typical melting furnace system for making continuous glass fibers. With this much molten material, the melting furnace and delivery system has great momentum and inertia, i.e. it is difficult and takes considerable time correct a change in the molten glass reaching the bushings following a furnace upset. A furnace upset is anything that makes a significant change in the way the melting furnace is operating, including a significant change in the throughput of molten glass through the delivery system, including the bushings. In the past it has been noticed that when a plurality of bushings were stopped from making desired fiber product and put into a hanging mode, to permit a chopper that had been pulling strands of fibers from the bushings to be rebuilt, that after a few minutes the conditions inside the melting furnace would change and that the automatic burner controls for the melter were changing conditions of the burners responding to the change(s) in the furnace. This is not desirable. Although improvements in melting furnace control and stability have been made through the decades that large melting furnaces have existed, excessive furnace upsets or disturbances still exist result in lower productivity and higher manufacturing costs.

### SUMMARY

It has been discovered that if enough additional cooling is applied upon, or soon after a bushing break out begins, and until the bushing is once again in a desired fiberization mode, to maintain a substantially constant throughput of molten material through the bushing as the molten material throughput during desired fiberization, the break rate of the bushing in the first 10-20 minutes, particularly in the first 10 minutes following a restart of desired fiberization of the bushing is substantially improved. By “substantially the same molten material throughput” is meant within about 96 to about 103 percent of the molten material throughput during desired fiberization, the latter throughput being the throughput after 20 minutes of desired fiberization. More typically the throughput during interruptions of desired fiberization is maintained to within about 97 to 102 percent of desired fiberization throughput, most typically within about 98 to about 102 percent. By very soon means within several minutes after the beginning of a breakout, typically within 5-7 minutes, more typically within 3 minutes and most typically within two or fewer minutes.

From the above discoveries, it is believed that if the throughput on at least many of the bushings on a melting furnace system, including a plurality of bushings and a melting furnace supplying molten material to the bushings, is maintained substantially constant, the stability of the melting furnace will be substantially improved and the fiberizing quality of the molten material flowing into the bushings will be substantially improved. By many of the bushings is meant at least about 25 percent of the operating bushings in the system. When most of the bushings are operated according to the invention, the melting furnace will operate at substantially constant throughput. By most of the bushings is meant at least about 65 percent of the operating bushings in the system. When substantially all of the bushings are operated according to the invention, the throughput of the melting furnace will not vary by more than 1-2 percent, except for power failures or other external interruptions. By substantially all of the bushings is meant at least about 95 percent of the operating bushings in the system.

According to the invention, the amount of cooling of the tip plate or orifice plate is substantially increased beginning soon after the beginning of a breakout, the increased cooling being sufficient to cause the set point thermocouple for the bushing to cause the electrical power to remain substantially the same during the breakout, bead out, hanging period and restart of the desired fiberization of the bushing as the power load on the bushing during desired fiberization. By very soon means within several minutes after the beginning of a breakout, typically before 5-7 minutes have expired, more typically within 3 minutes and most typically within two minutes or less. This can be achieved by using any of several conventional breakout detectors available to activate the additional cooling apparatus.

The invention includes a process of making fiber from a molten mineral or glass material by flowing the molten material into a fiberizing bushing comprising an orifice plate or tip plate having a plurality of holes therein, with or without tips, nozzles, each tip having an orifice therethrough that communicates through the orifice plate with the molten glass in the bushing, applying electrical power to the bushing causing the molten material to flow through the orifices in the orifice plate or in the tips to form fibers, cooling the just formed fibers using a plurality of cooling members held in place below and spaced from the orifice plate or tip plate a produce a desired fiberization mode, the improvement comprising, after the beginning of a bushing breakout until near the time the bushing is once again in a desired fiberization mode, applying additional cooling to the orifice plate or tip plate of the bushing to maintain the throughput of molten material from the bushing substantially constant. By near the time is meant within 0-4 minutes, more typically within 1-4 minutes, still more typically in less than 2 or 3 minutes on either side of the restart of desired fiberization and most typically within about 90 seconds and more typically within about 45 seconds, before or after, the bushing is once again fiberizing.

The invention also includes a process of making fiber from a molten mineral or glass material by flowing the molten material from a melting furnace through one or more forehearths and bushing legs into a plurality of fiberizing bushings, each bushing comprising an orifice plate or tip plate having a plurality of holes therein, with or without tips, nozzles, each tip having an orifice therethrough that communicates through the orifice plate or tip plate with the molten glass in the bushing, applying electrical power to each of the plurality of bushings causing the molten material to flow through the orifices in the orifice plate or in the tips to form fibers, cooling the just formed fibers using a plurality of cooling members held in place below and spaced from each orifice plate or tip plate a produce a desired fiberization mode, the improvement comprising, after the beginning of a bushing breakout in any of at least many of the plurality of bushings, only until near the time the bushing is once again in a desired fiberization mode, applying additional cooling to the orifice plate or tip plate of the bushing to maintain the throughput of molten material from the many bushings substantially constant.

It has also been discovered that when that is achieved, the electrical power load on the bushing remains at substantially the same magnitude during the breakout and/or hanging mode as the magnitude of power load on the bushing during the normal periods of desired fiberization. By “substantially the same power load” is meant within the range of about +/−1 percent of the power load on the bushing during desired fiberization, i.e. when the bushing has been operating normally for periods greater than about 20 minutes making good product fibers. From this discovery it is then possible to achieve the substantially same molten material throughput of the bushing by adding enough additional cooling for the tip plate or orifice plate, and controlling or throttleing the amount additional cooling, to maintain a substantially constant electrical power load on the bushing.

The invention also comprises a melting furnace system comprising a plurality of bushing assemblies for fiberizing a molten material coming from the melting furnace comprising an orifice plate containing a plurality of orifices or a tip plate comprising a plurality of nozzles, tips, through which molten glass flows to form fibers, and cooling members mounted beneath the orifice plate for cooling the molten glass as it exits the orifices in the orifice plate or tips, the improvement comprising apparatus for providing additional cooling for the orifice plate or tip plate of at least some of the bushing assemblies, each of some of the bushing assemblies comprising a device for quickly moving, generally vertically, the cooling members back and forth from a desired location for desired fiberizing to a desired location for “hanging”. By quickly is meant doing so within the first minute, more typically within 30 seconds, even more typically within 15 seconds and most typically in less than 5 seconds, from the time the apparatus is activated by either an operator or by a known sensor that senses when a bushing is either fiberizing desirably or when it is breaking out or hanging. More desirably, many of the bushing assemblies in the melting furnace system is so equipped, and even more desirably most bushing assemblies are so equipped.

The invention also comprises a bushing assembly for fiberizing a molten material comprising an orifice plate containing a plurality of orifices or a tip plate comprising a plurality of nozzles through which molten glass flows to form fibers, a controller for electrical power for the bushing, a set point temperature sensing member for sending a temperature signal to the controller and cooling members mounted beneath the orifice plate for cooling the molten glass as it exits the orifices in or nozzles on the orifice plate, the improvement comprising apparatus comprising a device for quickly moving, generally vertically, the cooling members back and forth from a desired location for fiberizing to a desired location for “hanging”. By quickly is meant doing so within the first minute, more typically within 30 seconds, even more typically within 15 seconds and most typically in less than 5 seconds, from the time the apparatus is activated by either an operator or by a known sensor that senses when a bushing is either fiberizing desirably or when it is breaking out or hanging.

The invention permits the molten material throughput and power load on the bushing to remain substantially constant while also maintaining a desired set point temperature of the orifice plate and/or in the molten glass above the orifice plate substantially constant. By “desired fiberiziation” is meant the condition where fibers are being pulled from a bushing at a speed similar to that produced by a product-forming machine like a chopper or winder, usually at more than 1000 feet per minute. By beading out or breaking out is meant the mode from the time the first fiber breaks out, or from the time the operator or sensor senses that one or more fibers have broken out, until every running tip has formed a bead of molten glass at the end of the tip, usually so heavy enough that it has fallen away from the tip to form a primary fiber. If one or more tips of the bushing are cold, i.e. cooler than the other tips, for some reason, those few tips will bead very slowly and need not be running a primary fiber for the bushing to be in the hanging mode. By “hanging” is meant a condition or mode where the fibers from the bushing have broken out and the bushing is in the mode where all, or almost all, of the operating tips are producing coarse, primary fibers and those primary fibers are moving downward due to their own weight, or are being pulled slowly by pull rolls, usually into a waste collection system or waste hopper. Thereafter, until the bushing is restarted, i.e. all or most of the primary fibers from the bushing are inserted into a high-speed pulling device like a winder or a chopper, the bushing remains in a hanging mode.

The apparatus comprises a bushing having cooling members that can be very quickly moved vertically at the action of the operator or an electrical activator that is activated by a sensor that responds to a breakout of the bushing. By “breakout” is meant that the fibers being pulled into a product forming device like a chopper or winder have all broken and are no longer being pulled by these type of machines, and until primary fibers coming from that bushing are once again started into a product forming device, the bushing is said to be “hanging”.

The cooling members are usually supported by one or more cross members, typically with a cross member outboard of and near each end of the bushing, that are supported with generally vertical members, each generally vertical member being, or including, a solenoid or a fluid cylinder or other vertical actuator. At least a part of each vertical support member is located at an elevation that is at a lower elevation than the orifice plate or tip plate of the bushing. By generally vertical is meant vertical and up to about 15 degrees off of vertical. The cooling members are designed to carry a cooling liquid or other fluid. Air and water are fluids, but other gases and other liquids can be also used.

The invention also includes a bushing assembly for fiberizing a molten material comprising an orifice plate containing a plurality of orifices or nozzles through which molten glass flows to form fibers and cooling members mounted beneath the orifice plate for cooling the molten glass as it exits the orifices in or nozzles on the orifice plate, the improvement comprising apparatus comprising one or more misters or foggers mounted adjacent each side of the bushing that upon activation produce a mist or fog of liquid adjacent an outer row of tips or orifices on each side of the bushing and upon deactivation cease the mist or fog. By mist is meant a plurality of small, about 40 to about 500 microns, liquid particles suspended in air and by fog is meant a majority of the liquid particles being very small, below about 40 microns, suspended in air. Most typically the mist or fog liquid is water, process water, city water, more desirably rain water, distilled water or deionized water. Air can be used as a carrier or atomizer for the liquid, but the fog or mist can be formed by the pressure in the manifold 50 and the type of nozzle or jet 52 used as is well known.

The invention also includes a bushing assembly for fiberizing a molten material comprising an orifice plate containing a plurality of orifices or nozzles through which molten glass flows to form fibers and cooling members mounted beneath the orifice plate for cooling the molten glass as it exits the orifices in or nozzles on the orifice plate, the improvement comprising apparatus comprising a device for quickly moving, generally vertically, the cooling members back and forth from a desired location for fiberizing to a desired location for “hanging” and apparatus comprising one or more misters or foggers mounted adjacent each side of the bushing that upon activation produce a mist of liquid adjacent an outer row of tips or orifices on each side of the bushing and upon deactivation cease the mist.

Each of the apparatus embodiments described above can also comprise one or more air tubes mounted below the orifice plate that can be activated or deactivated, and when activated causes a rapidly moving stream of air to flow downward away from the tip plate, inducing cooling air to generally laterally enter the vicinity near a bottom of the orifice plate or tips to cool the orifice plate or tips and the molten glass coming from the orifice plate or tips.

The invention also includes a process of making fiber from a molten material using the different apparatus described above, and combinations thereof. Fibers are formed by flowing the molten material into the fiberizing bushing having at least one generally vertical side wall, an orifice plate having holes therein, with or without tips, nozzles, each tip having an orifice therethrough that communicates through the orifice plate with the molten glass in the bushing, causing the molten material to flow through the orifices in the orifice plate or in the tips to form a meniscus below each operative orifice or tip and pulling a fiber from each meniscus, cooling the molten glass meniscus and just formed fibers, beads or primary fibers using a plurality of cooling members held in place below the orifice plate or tip plate with a mounting apparatus for mounting the plurality of cooling members, the improvement of the invention comprises, following the beginning of a breakout, moving the cooling members quickly, generally vertically, upward a distance of up to about 0.2 inch, typically up to about 0.15 inch and most typically up an amount from about 0.01 inch to about 0.2 inch to increase cooling of the orifice plate during hanging, and then moving the cooling members downward into an operating position near the time when the bushing has been put in a fiberizing condition

The invention also includes a process of making fiber from a molten material using the different apparatus described above, and combinations thereof. Fibers are formed by flowing the molten material into the fiberizing bushing having at least one generally vertical side wall, an orifice plate having holes therein, with or without tips, nozzles, each tip having an orifice therethrough that communicates through the orifice plate with the molten glass in the bushing, causing the molten material to flow through the orifices in the orifice plate or in the tips to form a meniscus below each operative orifice or tip and pulling a fiber from each meniscus, cooling the molten glass meniscus and just formed fibers, beads or primary fibers using a plurality of cooling members held in place below the orifice plate or tip plate with a mounting apparatus for mounting the plurality of cooling members, the improvement the comprising, following the beginning of a breakout, activating one or more misters and/or foggers spaced from adjacent each outer row of orifices or tips to produce a flow of mist and/or fog towards the tips or a bottom of the orifice plate, and then deactivating the misters and/or foggers near the time when the bushing is once again in a fiberizing condition.

The two methods described above can be combined, and in each of the methods, including the combined method, one or more air tubes can be activated following a breakout to induce a flow of air into the region beneath of the orifice plate to enhance cooling of the orifice plate.

In the methods of the invention, the rate of heat removal from the orifice plate or tip plate 8, using external means, is increased during hanging and decreased during fiberizing to maintain the molten material throughput substantially constant and also to maintain the electrical power load on the bushing substantially constant. The electrical power load on the bushing is monitored and the rate of heat removal is modified, especially when the bushing breaks out and when the bushing is again started fiberizing to maintain the electrical power load on the bushing within the range of about +/−1 percent, more typically within about +/−0.5 percent and most typically about +/−0.25 percent variation. In any event the electrical power load on the bushing is of secondary importance and is varied to maintain the molten material throughput substantially constant during desired fiberization periods and during breakouts and hanging modes, i.e. interruptions in the desired fiberization. The invention is also useful to maintain the desired molten material throughput of the bushings when it is necessary to interrupt desired fiberization to do maintenance on a chopper or winder pulling the fiber from the bushing(s).

Practice of the invention accomplishes much more than improving the performance of the bushing the invention is being used on. When all or most of the bushings on a melting furnace system are operated in the above manner, i.e. having substantially constant molten material throughput, the stability of the melting furnace, i.e. equilibrium, will be much improved, the quality, uniformity, of the molten glass reaching the bushings will be much improved, and the breakout rate of all the bushings will be substantially reduced. By “many of the bushings” is meant at least 25 percent of the operating bushings on the melting furnace system. The more bushings that are operated according to the invention on a melting furnace system, the more stable the melting furnace will become and the more improvement in break rate and cost. This will substantially increase the product productivity of the melting furnace system and substantially reduce the cost of every pound of fiber product produced according to the invention. Also, it is not necessary to replace or change the electrical power equipment used to control the bushing temperature, and because of the large number of bushings involved, thousands in the industry, this is a valuable factor.

The present invention is applicable to any system or bushing that converts molten material to continuous fibers and particularly to systems and bushings that operate at temperatures above 1000 degrees F. Materials suitable for converting in the present invention are polymers, metals and mineral materials including glasses, ceramic compounds or mixtures of ceramic materials, slags and the like. The invention is particularly useful in making continuous glass fibers and products made using such fibers. While the invention is applicable to any glass used to make fibers, E glass is the most common glass used to make continuous fiber.

When the word “about” is used herein it is meant that the amount or condition it modifies can vary some beyond that stated so long as the advantages of the invention are realized. Practically, there is rarely the time or resources available to very precisely determine the limits of all the parameters of ones invention because to do would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors disclosure and understanding the inventive concept, the objectives of the invention and embodiments disclosed, including the best mode known to the inventor, the inventor and others can, without inventive effort, explore beyond the limits disclosed using only ordinary skill to determine if the invention is realized beyond those limits, and when embodiments are found to be without any unexpected characteristics, those embodiments are within the meaning of the term about as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

### BRIEF DESCRIPTION OF THE DRAWINGS

FIG. 1 is a partial perspective view of a typical prior art bushing showing cooling members mounted beneath the fiberizing bushing.

FIG. 2 is a perspective view of a part of a prior art bushing assembly showing one prior art air tube for partially addressing the problem addressed much more thoroughly by the invention.

FIG. 3 is a partial perspective view of a bushing assembly of one embodiment of the invention.

FIG. 4 is a partial end view of the cooling member support system shown in FIG. 3 showing more details of this embodiment in a hanging mode of operation.

FIG. 5 is a partial end view of the cooling member support system shown in FIG. 3 showing more details of this embodiment in a desired fiberization mode of operation.

FIG. 6 is a cross sectional view near the end of a bushing assembly and showing another embodiment of the invention comprising cooling mist and/or fog generators.

FIG. 7 is a cross sectional view near the end of a bushing assembly of still another bushing assembly comprising both mist and/or fog generators and an assembly for quickly moving the cooling members towards and away from the bottom of the bushing.

### DETAILED DESCRIPTION

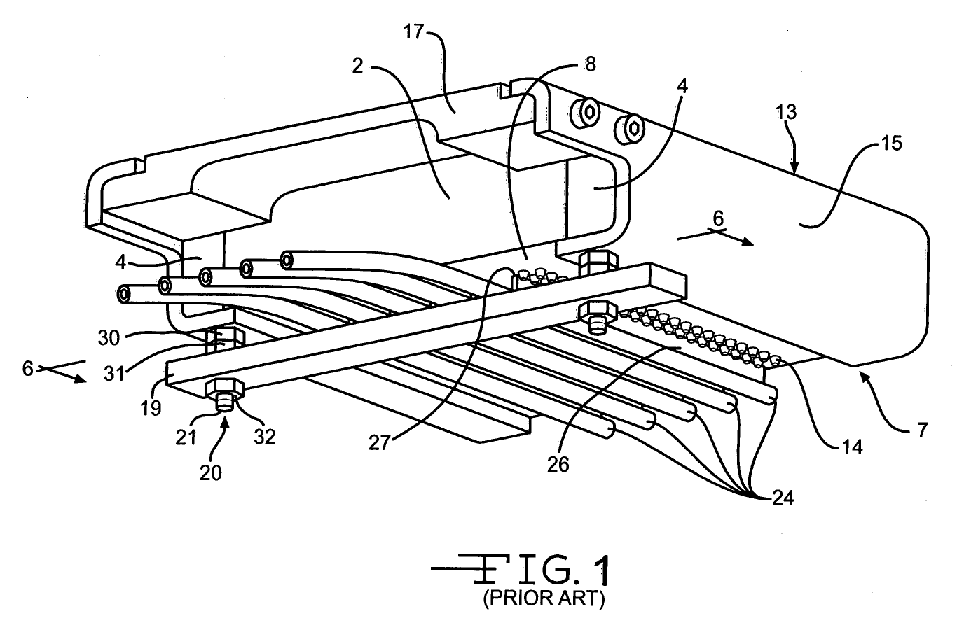

FIG. 1 is a partial perspective view of a typical mounted precious metal bushing assembly 7 including related hardware used to form glass fiber from molten glass. A bushing 2, typically made from a platinum/rhodium alloy having a rhodium content ranging from ten to about thirty percent, typically 20-22 percent is encompassed in a mount 13. The bushing 2 comprises conventional sidewalls, end walls in a known manner. The bushing 2 also comprises a tip plate 8 having a plurality of tips, nozzles, 14 welded to or formed from the tip plate 8. The tip plate 8, that can be just an orifice plate with out tips surrounding orifices in the orifice plate. The bushing 2 is electrically heated by connecting to an electrical input via a conventional terminal (not shown) on each end-wall, or sidewall, of the bushing 2 in a known manner. Only one end of the bushing is shown in FIG. 1 because the other end is identical except that the cooling tubes are not always bent, but extend straight to conventional cooling fluid, usually process water, supply hoses (not shown here).

The bushing 2 is contained in conventional refractory material 4 in a known mounting frame 13 that holds a top of the bushing 2 against a refractory surface around an orifice in the bottom of a forehearth of a furnace. The frame 13, typically made of stainless steel, comprises side rails 15 held in a spaced apart manner by a cross member 17 at each end of the side rails 15. Conventional insulating refractory castable 4 and refractory paper or felt is used between the bushing 2 and the mounting frame 13 in a known manner to provide electrical and thermal insulation for the bushing 2. Normally, the tips 14 are arranged in rows down the length of the bushing 2, but can be in rows running along the width of the bushing 2 as is known. In the bushing shown in FIG. 1, the tips 14 are arranged in pairs of rows staggered, running along the length of the bushing in a known manner, e.g. as shown in U.S. Pat. No. 4,337,075.

A space is left on the bottom of the orifice plate in between each double row of tips to allow cooling members such as cooling tubes 24, each having a heat removing fin 26 attached to their top surface. A tremendous amount of heat must be very quickly removed from the molten glass extruding from the tips 14 at temperature over 2000 degrees F. and the cooling tubes 24 with their fins 26 perform this function, supplemented by a flow of air pulled into the area of the tips and fibers by the glass fibers moving rapidly downward, away from the tips 14. Although a cooling tube 14 was removed, in this figure, to better show the double row of tips 14, it is typical to use a cooling tube 24 having a single fin 26 in the positions just outside the outer row of tips 14 such that each row of tips is adjacent to a fin and cooling tube and adjacent to, but staggered with, another row of tips.

The cooling tubes 24 are supported in a known manner, such as disclosed in U.S. Pat. No. 5,244,483, its disclosure herein incorporated by reference, and by the method shown in FIG. 1. While the cooling tubes 24 shown here are oval in cross-section, they can be any reasonable shape such as round, square, rectangular with or without radiused ends, etc. as is known. The cooling tubes 24 are supported at each end near each end of the bushing 2 with a crossbar 19 that is held, in an vertically adjustable manner, with a threaded rod 21 that is attached in any reasonable manner to the bottom surface of one of the side rails 15, typically by being threaded into the side rail 15 and secured from turning by a lock nut 30. An adjustable stop nut 31 is threaded onto each rod 21 such that the bottom surface of the stop nut 31 serves to position the top surface of the crossbar 19 and the bottom surface of the cooling tubes 24, hence also a top surface 27 if each cooling fin 26. The vertical distance between the top surface 27 of the cooling fins 26 and a plane passing along the bottom of the tips 14 is typically in a range of about +/−0.0625 inch.

FIG. 1 shows a portion of a mounted bushing 7 ready to be installed beneath a forehearth leg. Some of the cooling tubes 24 under the last double row of tips 14 have been left off of this figure to better show the tips 14 and the orifice plate 8. The bushing 2, because of its very hot and fairly fragile nature at operating temperature, is surrounded with insulation 4 in a known manner inside a stainless steel mounting frame 13 having side members 15 and cross members 17. The cooling tubes 24 are held in place near each end of the bushing 2 with a support bar 19 that can be adjusted vertically with corner vertical support assemblies 20. Each corner vertical support assembly 20 comprises a threaded rod 21, welded to, or screwed into threaded holes in, a lower portion of the side members 15, a lock nut 30 tightened against the bottom of the side member 15 to lock and support the threaded rod 21 in place, an adjustable stop nut 31 on the threaded rod 21 positioned at a desired level to locate a top 27 of the fins 26 at the desired position with respect to the tips 14 and the orifice plate 8, and a follower nut 32 to raise a top of the support bar 19 tightly against the adjustable stop nut 31 and to support the bottom of the cross member 19. This arrangement permits the cooling tubes 24 to be raised or lowered as a group to optimize the cooling of each tip 14, each hot meniscus below each tip 14 and each fiber being drawn from each meniscus. This adjustment is slow because each corner vertical support 21 must be adjusted and each requires several minutes to adjust by sequentially running the follower nut 32 down each threaded rod 21 a desired amount and then rotating the stop nut 31 down to snug against the top of the cross member 19. In the prior art, the cooling tubes, fins or other cooling members remained in the adjusted position, keeping the distance between the tops 27 of the fins 26 and the bottom of the tips 14 the same, during both fiberizing and hanging conditions. A cooling fluid, like process water, runs through the cooling tubes 24 to provide cooling to the cooling tubes 24, with or without the fins 26.

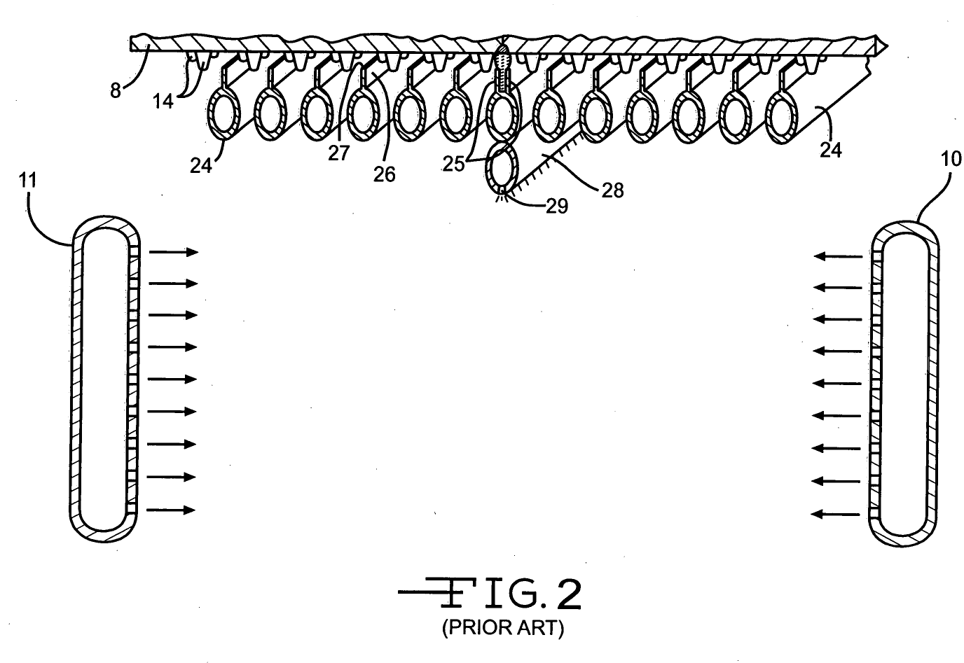

FIG. 2 shows a prior art modification of FIG. 1 having one or more air tube 28, each having a slot or series of spaced apart holes 29 in the bottom of the air tube 28, mounted beneath one of the cooling members 24. When the bushing breaks out the air tube(s) is caused to emit a rapidly downward moving stream of air that creates a partial vacuum or low pressure zone in the area immediately beneath the tips 14. This partial vacuum then induces flows of air from the surroundings into the zone beneath the tips 14 and towards the air tube 28 or below the air tube 28 and finally downward with the primary fibers. Conventional air ducts 10 and 11 are mounted on each side of the bushings and direct refrigerated air towards the array of fibers in a conventional manner. The air ducts 10 and 11 can be of various dimensions and at various heights with respect to the bushing, and various distances from the bushings as is well known.

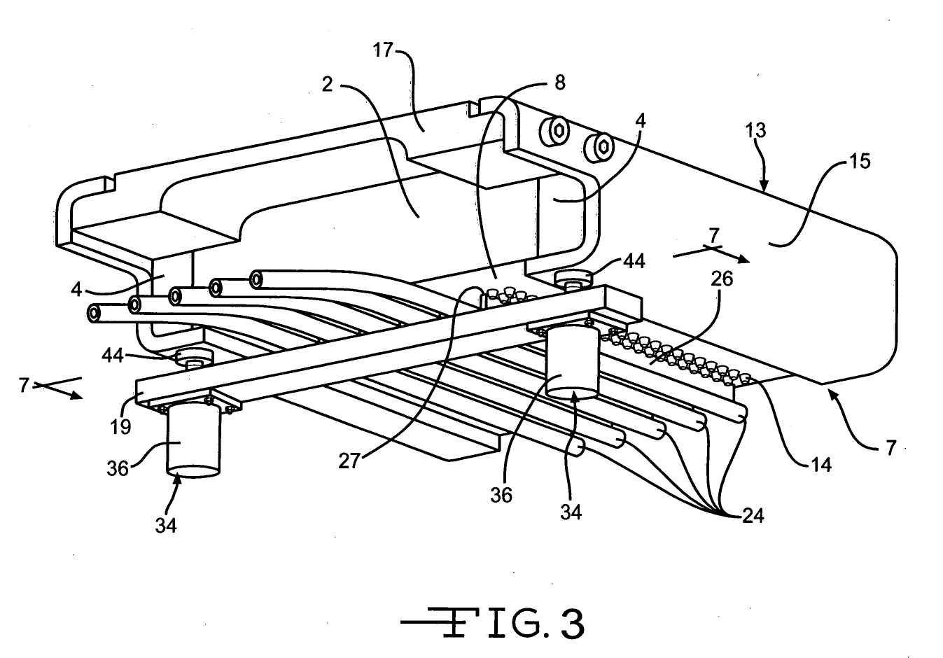

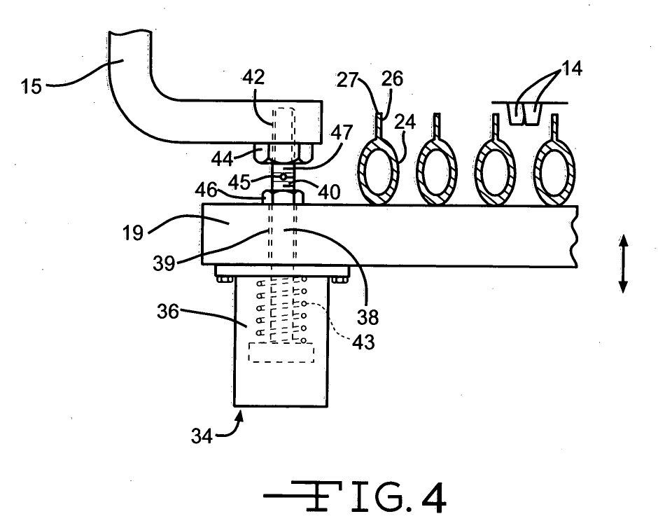

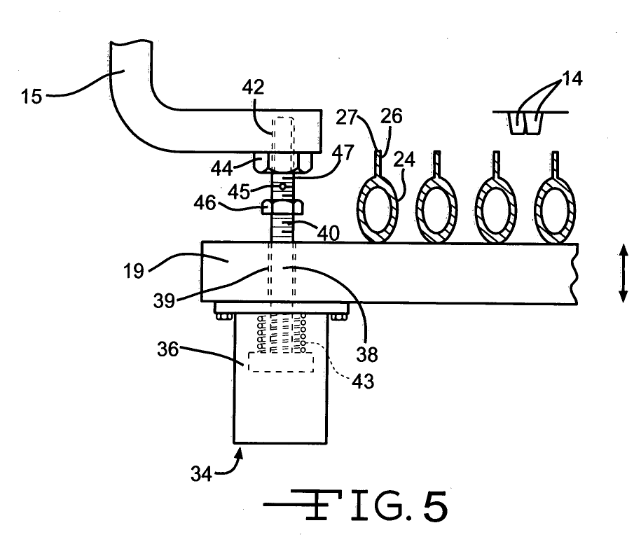

FIG. 3 shows the mounted bushing of FIG. 1, but the cooling hardware has been modified to produce an embodiment of the invention and to permit fast vertical adjustment of all the cooling tubes 24, typically as a group, with respect to the orifice or tip plate 8 and the bottom of the tips 14. In this embodiment everything is the same as in the assembly of FIG. 1 except that the vertical support assemblies 20 are replaced with a vertical actuator like an electrical solenoid assembly 34. The electrical assembly 34 comprises an electrical solenoid 36 attached to the cross member 19 in any suitable manner. The solenoid 36 has a shaft 38 (FIG. 4) that passes through an oversize hole 39 in the cross member 19 and comprises a threaded portion 40 above the cross member 19. The end of the shaft 38 is attached directly or indirectly to the side rail 15, such as being screwed into a threaded hole in the side rail 15 as shown in FIGS. 4 and 5. A lock nut 44 tightened against the bottom of the side rail 15 secures the shaft 38 in the side rail 15. The shaft 38 can be attached to the side rail 15 in other ways such as by welding, press fit, or soldering, etc., or indirectly by being turned into a nut or other object, attached to the side rail 15, and having a threaded hole therein. The shaft 38 can optionally have small holes 45,47, typically at 90 degrees from each other for insertion of a rod or similar tool to rotate the shaft 38 when desired.

An adjustable stop nut 46 on the threaded portion 40 of the shaft 38 fixes the maximum height that the cross member 15, and hence the maximum height the tops 27 of the fins 26 on the cooling tubes 24 can reach. The adjustable stop nut 46, on each of the four solenoid assemblies 34, is adjusted to locate the tops 27 of the fins 26 with respect to the bottom surface of the orifice plate 8 and the bottoms of the tips 14 during the hanging mode of the bushing 2. Although only one end of the bushing assembly is shown in FIG. 3, the other end is the same.

FIG. 5 shows the fiberizing position of the support member 29 and the cooling members 24 with the fins 26. In this embodiment the solenoid 36 is energized in the fiberizing mode such that the support member 19 and the cooling members 24 with fins 26 is pulled downward, away from the orifice plate 8 and the tips 14, to the fiberizing position. When the operator or a sensing device senses that the bushing has broken out, the solenoid 36, in this embodiment, is de-energized causing the spring 43 to push the support member 19 and cooling members 24 and fins 26 to be moved upwardly, towards the orifice plate 8 and tips 14, to the hanging position shown in FIG. 4. The amount of movement of the top 27 of the cooling fins 26 between the operating position of FIG. 5 and the hanging position of FIG. 4 varies with the type and size of the bushing, the type of cooling members being used and the conditions surrounding the orifice plate 8 and the tips 14, but in the embodiment shown in FIGS. 2-5 The amount of movement of the top 27 of the cooling fins 26 between the operating position of FIG. 5 and the hanging position of FIG. 4 varies with the type and size of the bushing, the type of cooling members being used and the conditions surrounding the orifice plate 8 and the tips 14, but in the embodiment shown in FIGS. 2-5 the distance typically is in the range of about 0.01 or 0.03 inch to about 0.2 inch, more typically about 0.04 to about 0.45 and most typically about 0.06 to about 0.37. The movement of the cooling members is typically limited to less than about 0.2 inch and should never get so close to a tip 14 or the orifice plate or tip plate 8 so as to cause an electrical short.

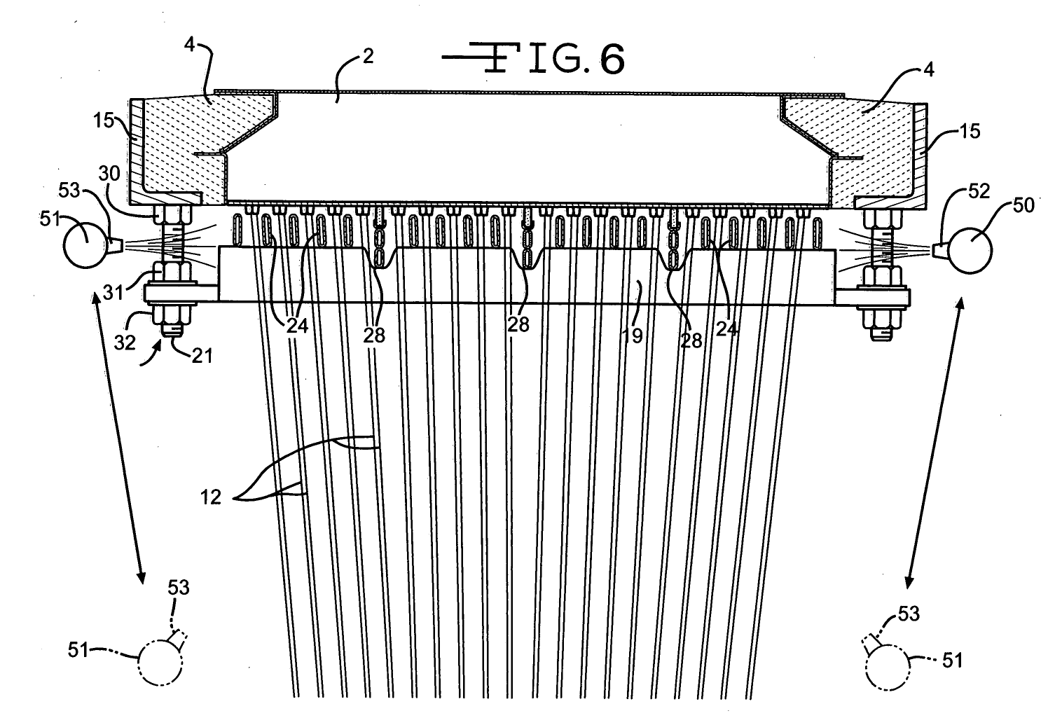

FIG. 6, a cross section of a bushing assembly similar to that shown in FIG. 1, along lines 6-6, shows a different embodiment of the invention. In this embodiment three conventional spaced apart air tubes 28 are shown along with ceramic supports 25, sintered mullite or other electrical and glass resistant ceramic, all this being conventional. In the bushing assembly of FIG. 6, commercially available fogging and/or misters 52 are located in a novel location, either connected to a manifold 50 as shown or spaced apart below the orifice plate 8 and tips 14 and spaced from the outside tips 14 of the bushing 2.

It has been conventional to use water sprays, often called pad or pot sprays, located far below, substantially more than the orifice plate 8, to spray cooling water into the array of solidified, hot fibers to cool them sufficiently to prevent damage to the chemical sizing conventionally applied to the surface of the fibers still further from the orifice plate 8. It has not been known to locate foggers and or misters close to the orifice plate 8 and the outside tips 14 down the sides, running along the length of the bushing 2, and to operate the foggers and/or misters 52 when the bushing is hanging. One or more conventional valves (not shown) in the water and/or compressed air line(s) supplying the misting and/or foggers 52, or the manifold 50, open to cause a fog or mist to be emitted into a region immediately below the tips 14, near the time when the bushing breaks out, to prevent the orifice plate 8 from over-heating during the hanging mode, and then are closed near the time the bushing is put back into the fiberizing mode.

The misting or fogging jets 52 and manifolds 50, a manifold 50 with a plurality of jets 52 on opposite sides, normally the long side, of the orifice or tip plate 8 of the bushing 2, can be located at different vertical distances below the bottom of the orifice or tip plate 8, and at different angles and distances from the centerline of the orifice or tip plate 8, as shown in FIG. 6. The manifold can be mounted to be adjustable vertically, laterally, and to rotate sufficiently to point the jets 52 in the desired direction using conventional mounts. The foggers and/or misters are turned on near the time the bushing starts to break out and are turned off near the time that desired fiberization is once again started. By near the time is meant within a period of time ranging from 0.001 second to about 2 minutes from the time that the operator notices, or a sensor senses, that the bushing is breaking out, or from before or after the time that the operator starts the strand into a product producing machine such as a winder or a chopper. The fog or mist entering the region immediately beneath the orifice or tip plate, i.e. from about 1 to about 12 inches, more typically from about 2 to about 10 inches, and most typically from about 2.5 inches to about 9 inches from the bottom of the tips 14. The number of jets or nozzles 52, the distance from the array of fibers and the vertical distance from the bottom of the tips and the total rate of cooling liquid mist or fog sprayed towards the orifice or tip plate 8 and on the array of primary fibers 12 will depend upon the size of the bushing and what other cooling means are being used, but when used, will be determined by the objective of maintaining the molten throughput of the bushing substantially constant during the breakout and hanging mode as it was during desired fiberization periods.

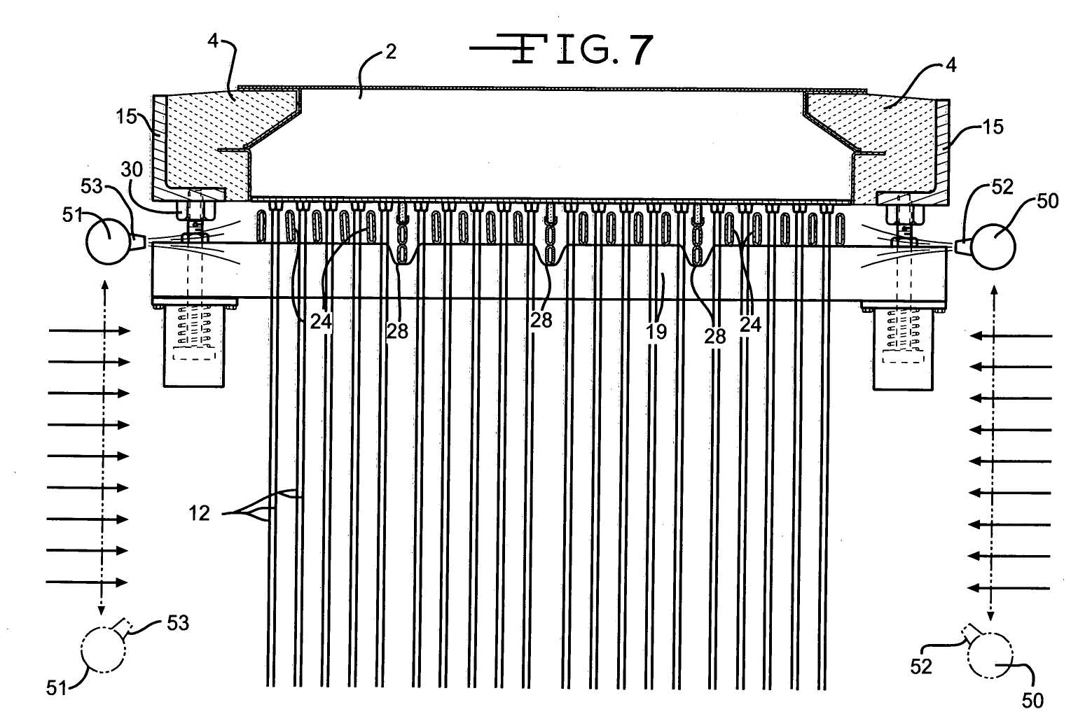

The invention also includes a combination of the apparatus for cooling the orifice plate 8 and tips 14 disclosed in FIGS. 3-6 and such an embodiment is shown in FIG. 7. This embodiment, particularly when used with one or more air tubes 28, provides more cooling capability and flexibility of the tips 14 and orifice or tip plate 8 during the hanging mode of the bushing, and permits more optimization of each cooling contributor. This combination of cooling apparatus enhances temperature stability and reduces break rate, breaks per day, on the larger bushings used in the industry, for example bushings having more than 4500 tips and can be needed at times or with different bushing assemblies having fewer than 4500 tips.

One can determine whether more or less cooling of the orifice plate 8 and tips 14 is needed on any given bushing assembly by monitoring the magnitude of power the automatic temperature controller for the bushing is applying to the bushing during the fiberizing mode and the hanging mode. The ideal is for this power magnitude to remain constant during both modes and during transition from one mode to the other mode. One can add or remove additional cooling apparatus of the invention, move the cooling members closer or less close to the orifice plate 8 and/or tips 14, or increase or decrease the flow rate of the cooling liquid, like water, exiting the forgers and/or misters 52 shown in the embodiments of FIGS. 6 and 7 to improve the temperature uniformity of the molten material above the orifice plate 8 by monitoring the power load on the bushing and acting in the manner taught by this disclosure to keep the power requirements at as constant a level as possible.

Different embodiments employing the concept and teachings of the invention will be apparent and obvious to those of ordinary skill in this art and these embodiments are likewise intended to be within the scope of the claims. Nor does the inventor intend to abandon or dedicate to others any disclosed inventions that are reasonably disclosed but that do not appear to be literally claimed below, but rather intends those embodiments to be within the scope of the broad claims, either literally or as equivalents to the embodiments that are literally included.

1. A bushing assembly for making fibers from a molten mineral material comprising a bushing comprising an orifice plate or tip plate, cooling members mounted beneath the orifice plate to cool the molten material and an adjustable support for the cooling members, the improvement comprising one or more actuators for quickly moving the cooling members from a fiberizing position in an upward direction to a hanging position and for quickly moving the cooling members back downwardly to a fiberizing position.

2. The assembly of claim 1 wherein the actuator is an electrical solenoid.

3. The assembly of claim 1 wherein the distance between the fiberizing position and the hanging position is in the range of about 0.01 inch to about 0.2 inch.

4. The assembly of claim 3 wherein the actuator is a fluid cylinder.

5. The assembly of claim 1 wherein the actuator is capable of moving the cooling member from one mode of operation to another mode of operation within 30 seconds.

6. The assembly of claim 2 wherein the actuator is capable of moving the cooling member from one mode of operation to another mode of operation within 30 seconds.

7. The assembly of claim 1 wherein the actuator is capable of moving the cooling member from one mode of operation to another mode of operation within 15 seconds.

8. The assembly of claim 2 wherein the actuator is capable of moving the cooling member from one mode of operation to another mode of operation within 15 seconds.

9. The assembly of claim 1 wherein the assembly further comprises one or more air tubes having a slot or plurality of spaced apart openings in the lower portion of each air tube.

10. The assembly of claim 2 wherein the assembly further comprises one or more air tubes having a slot or plurality of spaced apart openings in the lower portion of each tube.

11. The assembly of claim 6 wherein the assembly further comprises one or more air tubes having a slot or plurality of spaced apart openings in the lower portion of each tube.

12. The assembly of claim 7 wherein the assembly further comprises one or more air tubes having a slot or plurality of spaced apart openings in the lower portion of each air tube.

13. The assembly of claim 8 wherein the assembly further comprises one or more air tubes having a slot or plurality of spaced apart openings in the lower portion of each air tube.

14. The assembly of claim 1 wherein the assembly further comprises one or more misters and/or foggers laterally spaced from, and below, the orifice plate of the bushing for causing a for and/or mist of cooling liquid to flow into a region immediately below the orifice plate.

15. The assembly of claim 2 wherein the assembly further comprises one or more misters and/or foggers laterally spaced from, and below, the orifice plate of the bushing for causing a for and/or mist of cooling liquid to flow into a region immediately below the orifice plate.

16. The assembly of claim 9 wherein the assembly further comprises one or more misters and/or foggers laterally spaced from, and below, the orifice plate of the bushing for causing a for and/or mist of cooling liquid to flow into a region immediately below the orifice plate.

17. The assembly of claim 10 wherein the assembly further comprises one or more misters and/or foggers laterally spaced from, and below, the orifice plate of the bushing for causing a for and/or mist of cooling liquid to flow into a region immediately below the orifice plate.

18. The assembly of claim 11 wherein the assembly further comprises one or more misters and/or foggers laterally spaced from, and below, the orifice plate of the bushing for causing a for and/or mist of cooling liquid to flow into a region immediately below the orifice plate.

19. The assembly of claim 12 wherein the assembly further comprises one or more misters and/or foggers laterally spaced from, and below, the orifice plate of the bushing for causing a for and/or mist of cooling liquid to flow into a region immediately below the orifice plate.

20. The assembly of claim 13 wherein the assembly further comprises one or more misters and/or foggers laterally spaced from, and below, the orifice plate of the bushing for causing a for and/or mist of cooling liquid to flow into a region immediately below the orifice plate.

21. A bushing assembly for making fibers from a molten material comprising a bushing, comprising an orifice plate with or without tips, cooling members mounted beneath the orifice plate to cool the molten material and an adjustable support for the cooling members, the improvement comprising one or more foggers and/or misters laterally spaced from, and below, a side of the orifice plate of the bushing for causing a for and/or mist of cooling liquid to flow into a region immediately below the orifice plate.

22. The assembly of claim 21 comprising one or more air tubes having a slot or plurality of spaced apart openings in the lower portion of each air tube, the air tube located below at least one of the cooling members.

23. An assembly of claim 21 wherein the assembly comprises one or more manifolds to which the misters and/or foggers are connected.

24. A process of making fiber from a molten material by flowing the molten material into an electrically heated bushing having at least one generally vertical sidewall, an orifice plate or tip plate having a plurality of orifices therein, causing the molten material to flow through the bushing to form fibers in a continuous manner to achieve desired fiberization, the bushing having a desired throughput of molten material during desired fiberization, the improvement comprising substantially increasing the rate of heat removal from the orifice or tip plate after the bushing begins a breakout to maintain the throughput of molten material through the bushing substantially constant during a hanging mode with the throughput of the bushing during desired fiberization, and then stopping this increased rate of heat removal near the time when the bushing is restarted into desired fiberization.

25. The process of claim 24 wherein electrical power load on the bushing is monitored, and whereby the rate of heat removal is modified to maintain the electrical power load on the bushing substantially constant from before a break out until the bushing is once again in a desired fiberization mode.

26. The process of claim 24 wherein the bushing is heated electrically and wherein the electrical power load on the bushing is monitored, and whereby the rate of heat removal is modified to maintain the electrical power load on the bushing within the range of +/−one percent variation.

27. The process of claim 25 wherein the bushing is heated electrically and wherein the electrical power load on the bushing is monitored, and whereby the rate of heat removal is modified to maintain the electrical power load on the bushing within the range of +/−one percent variation.

28. The process of claim 24 wherein the rate of heat removal is increased by using a heat removing technique selected from the group consisting of moving the cooling members quickly closer to the orifice plate, directing a fog and/or a mist of cooling liquid into the region beneath the orifice plate, and combinations thereof.

29. The process of claim 28 further comprising the use of an air tube having a slot or a plurality of holes in its lower portion to increase the rate of heat removal.

30. The process of claim 27 wherein the rate of heat removal is increased by using a heat removing technique selected from the group consisting of moving the cooling members quickly closer to the orifice plate, directing a fog and/or a mist of cooling liquid into the region beneath the orifice plate, and combinations thereof.

31. The process of claim 30 further comprising the use of an air tube having a slot or a plurality of holes in its lower portion to increase the rate of heat removal.

32. A method of making fibers from molten mineral or glass material in a melting furnace system comprising a plurality of bushing assemblies, each assembly comprising an electrically heated bushing comprising an orifice plate or a tip plate, each having a plurality of orifices therein, comprising flowing the molten material into the bushing to cause the molten material to flow through the orifices and form fibers, cooling the fibers using a plurality of cooling members beneath and spaced from the orifice plate or tip plate and pulling the cooled fibers away from the bushing, resulting in a desired fiberization mode, the improvement comprising after a breakout of the bushing begins and during the time the bushing is making primary fibers, applying additional cooling to the orifice plate or tip plate until near the time the bushing is once again in a desired fiberization mode to cause the throughput of molten material from the bushing to remain substantially constant from desired fiberization mode and during at least most of the time the bushing is making primary fibers.

33. The method of claim 32 wherein the additional cooling is applied by activating one or more actuators for quickly moving the cooling members from a fiberizing position in an upward direction to a hanging position and for quickly moving the cooling members back downwardly to a fiberizing position.

34. The method of claim 33 wherein the actuator is an electrical solenoid.

35. The method of claim 32 wherein the distance between the fiberizing position and the hanging position is in the range of about 0.01 inch to about 0.2 inch.

36. The method of claim 33 wherein the actuator is a fluid cylinder.

37. The method of claim 33 wherein the actuator is capable of moving the cooling member from one mode of operation to another mode of operation within 10 seconds.

38. The method of claim 32 wherein the bushing assembly further comprises one or more air tubes having a slot or plurality of spaced apart openings in the lower portion of each air tube.

39. The method of claim 33 wherein the bushing assembly further comprises one or more air tubes having a slot or plurality of spaced apart openings in the lower portion of each tube.

37. The method of claim 37 wherein the bushing assembly further comprises one or more air tubes having a slot or plurality of spaced apart openings in the lower portion of each tube.

38. The method of claim 32 wherein the bushing assembly further comprises one or more misters and/or foggers laterally spaced from, and below, the orifice plate of the bushing for causing a for and/or mist of cooling liquid to flow into a region immediately below the orifice plate.

39. The method of claim 33 wherein the bushing assembly further comprises one or more misters and/or foggers laterally spaced from, and below, the orifice plate of the bushing for causing a for and/or mist of cooling liquid to flow into a region immediately below the orifice plate.

40. The method of claim 37 wherein the bushing assembly further comprises one or more misters and/or foggers laterally spaced from, and below, the orifice plate of the bushing for causing a for and/or mist of cooling liquid to flow into a region immediately below the orifice plate.

41. A process of making fibers from molten mineral or glass material in a melting furnace system comprising a melting furnace, one or more forehearths, one or more bushing legs and a plurality of bushings comprising flowing the molten material into a plurality of bushings, each bushing comprising an orifice plate or a tip plate, each having a plurality of orifices therein, supplying electrical power to each operating bushing to heat the bushing and to cause the molten material to flow through the orifices and form fibers, cooling the fibers using a plurality of cooling members beneath and spaced from the orifice plate or tip plate and pulling the cooled fibers away from the bushing, resulting in a desired fiberization mode, the improvement comprising, in at least many of the bushings, after a breakout of each of the many the bushing begins and during the time the bushing is making primary fibers, applying additional cooling to the orifice plate or tip plate of each of the at least many bushings until near the time each of the at least many bushings is once again in a desired fiberization mode to cause the throughput of molten material from each of the at least many bushings to remain substantially constant from desired fiberization mode and during at least most of the time the bushing is making primary fibers.

42. A melting furnace system for melting a mineral or glass material and for converting the resulting molten material into fibers, the system comprising a plurality of bushing assemblies for making fibers from the molten material, each bushing assembly comprising an electrically heated bushing comprising an orifice plate or tip plate, cooling members mounted beneath the orifice plate or tip plate to cool the tip plate or orifice plate and molten material exiting the orifice plate or tip plate and an adjustable support for the cooling members, the improvement comprising one or more additional cooling apparatus for providing additional cooling to the orifice plate or tip plate of some bushings while those bushings are in a hanging mode and one or more actuators on each of the bushing assemblies comprising the some bushings for activating and deactivating the additional cooling apparatus.

43. The system of claim 42 wherein the additional cooling apparatus is on many bushing assemblies.

44. The system of claim 44 wherein the additional cooling apparatus is on most of the operating bushing assemblies.

45. The system of claim 42 wherein the one or more actuators quickly move the cooling members from a fiberizing position in an upward direction to a hanging position and for quickly moving the cooling members back downwardly to a fiberizing position.

46. The system of claim 44 wherein the one or more actuators quickly move the cooling members from a fiberizing position in an upward direction to a hanging position and for quickly moving the cooling members back downwardly to a fiberizing position.

47. The system of claim 45 wherein the distance between the fiberizing position and the hanging position is in the range of about 0.01 inch to about 0.2 inch.

48. The system of claim 46 wherein the distance between the fiberizing position and the hanging position is in the range of about 0.01 inch to about 0.2 inch.

49. The system of claim 44 wherein the actuator is an electrical solenoid.

50. The system of claim 45 wherein the actuator is an electrical solenoid.

51. The system of claim 46 wherein the actuator is an electrical solenoid.

52. The system of claim 44 wherein the assembly further comprises one or more air tubes having a slot or plurality of spaced apart openings in the lower portion of each air tube.

53. The assembly of claim 45 wherein the assembly further comprises one or more air tubes having a slot or plurality of spaced apart openings in the lower portion of each tube.

54. The assembly of claim 46 wherein the assembly further comprises one or more air tubes having a slot or plurality of spaced apart openings in the lower portion of each tube.

55. The assembly of claim 50 wherein the assembly further comprises one or more air tubes having a slot or plurality of spaced apart openings in the lower portion of each air tube.

56. The assembly of claim 42 wherein the apparatus for additional cooling comprises one or more misters and/or foggers laterally spaced from, and below, the orifice plate or tip plate of the bushing for causing a for and/or mist of cooling liquid to flow into a region immediately below the orifice plate or tip plate.

57. The assembly of claim 43 wherein the apparatus for additional cooling comprises one or more misters and/or foggers laterally spaced from, and below, the orifice plate or tip plate of the bushing for causing a for and/or mist of cooling liquid to flow into a region immediately below the orifice plate or tip plate.

58. The assembly of claim 44 wherein the apparatus for additional cooling comprises one or more misters and/or foggers laterally spaced from, and below, the orifice plate or tip plate of the bushing for causing a for and/or mist of cooling liquid to flow into a region immediately below the orifice plate or tip plate.

59. The assembly of claim 45 wherein the apparatus for additional cooling comprises one or more misters and/or foggers laterally spaced from, and below, the orifice plate or tip plate of the bushing for causing a for and/or mist of cooling liquid to flow into a region immediately below the orifice plate or tip plate.

60. The assembly of claim 47 wherein the apparatus for additional cooling comprises one or more misters and/or foggers laterally spaced from, and below, the orifice plate or tip plate of the bushing for causing a for and/or mist of cooling liquid to flow into a region immediately below the orifice plate or tip plate.
